(19) United States
(12) Patent Application Publication
(10) Pub. No.: US 2007/0121919 A1
(43) Pub. Date: May 31, 2007

(54) Creating voice ring tone

(76) Inventor: Timothy Kay, Los Altos, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/540,326

(22) Filed: Sep. 28, 2006

Related U.S. Application Data
(60) Provisional application No. 60/722,148, filed on Sep. 29, 2005.

(51) Int. Cl. H04M 1/00; H04M 3/00

(52) U.S. Cl. 379/373.04

(57) ABSTRACT

A ring tone service to create a downloadable voice ring tone in response to receiving a phone call is described herein. The ring tone service detects an incoming phone call from a phone device to a service phone number associated with the ring tone service. An answering message allows a caller to start an audio response to be recorded into an audio data file. A notification message including information to locate the audio, such as a URL link that will cause a phone device to download a ring tone, is sent to the phone number associated with the calling phone device. A properly formatted ring tone is available for the phone device to download following the link information included in the notification message.

### CROSS-REFERENCE TO RELATED APPLICATIONS

This application is related to, and claims the benefit of, U.S. Provisional Patent Application No. 60/722,148, filed on Sep. 29, 2005 and entitled “Method and Process to Create Voice Ring Tones,” which is hereby incorporated by reference.

### TECHNICAL FIELD

The present invention relates to creating ring tones, and more particularly, to creating downloadable ring tones for a phone device.

### BACKGROUND

A ring tone is the sound that a device emits to notify the user of some event, such as call appearance, message arrival or battery level warning. For example, a cell phone device may allow the user to choose a ring tone that should be played when a call appears or another ring tone that should be played when a short message arrives. Some devices have the capability to receive additional ring tones from an external source. Such ring tones are said to be downloadable. Some devices can play ring tones that closely approximate recorded audio. Recorded audio can be stored as an audio data file. Ring tones created from recorded audio are called real tones, voice tones, true tones or natural tones.

Additionally, a ring tone can be sent to a device that includes a messaging service and a browser. Such a device, when receiving a message containing a URL (Universal Resource Locator), is capable, under control of the user or automatically, of steering the browser to the URL. Usually, a messaging service offers messaging functions such as SMS (Short Message Service), MMS (Multimedia Messaging Service) or WAP (Wireless Application Protocol) push messages. Sending a message containing a URL of a ring tone to a phone is called sending a ring tone to a phone.

Ring tones may be made available for a device to download in a variety of ways. When a browser in the device connects to a URL that contains a ring tone of the right format, the browser will download the ring tone to the device. Alternatively, a user can also create his/her own ring tones in a computer using various software tools. The created ring tones can then be downloaded to the user's device using computer-device connectivity such as a serial cable, a USB cable, infrared or Bluetooth.

However, using a computer running special software tools for ring tone creation may be cumbersome for a user.

### SUMMARY

A ring tone service creates a downloadable voice ring tone in response to receivng a phone call. The ring tone service detects an incoming phone call from a phone device to a service phone number associated with the ring tone service. An answering message allows a caller to start an audio response to be recorded into an audio data file. A notification message including information to locate the audio, such as a URL link that will cause a phone device to download a ring tone, is sent to the phone number associated with the calling phone device. A properly formatted ring tone is available for the phone device to download following the link information included in the notification message.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 illustrates one embodiment of a phone device capable of creating and downloading a voice ring tone through a network;

FIG. 2 illustrates one embodiment of system components for a ring tone service system to create and download voice ring tones through a network;

FIG. 3 illustrates one embodiment of a process for serving a ring tone to a phone device in accordance with the system of FIG. 2;

FIG. 4 illustrates one embodiment of a ring tone service to create a downloadable ring tone by receiving a phone call in accordance with the system of FIG. 2;

FIG. 5 illustrates one embodiment of a process for serving a ring tone to a phone device in accordance with the system of FIG. 2;

FIG. 6 illustrates one example of a typical computer system which may be used in conjunction with the embodiments described herein.

### DETAILED DESCRIPTION

In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

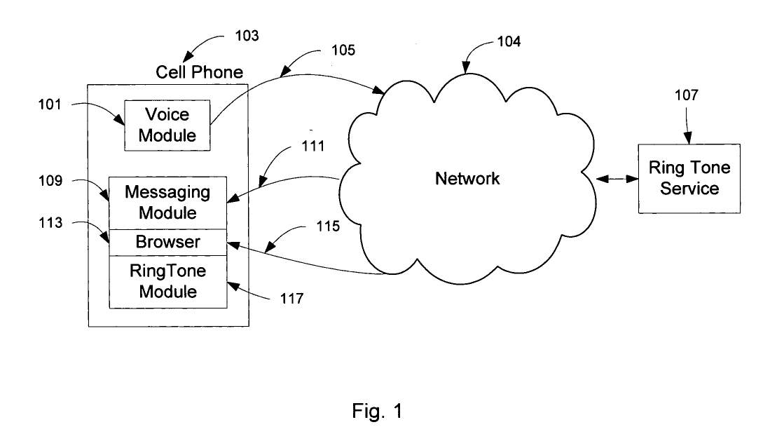

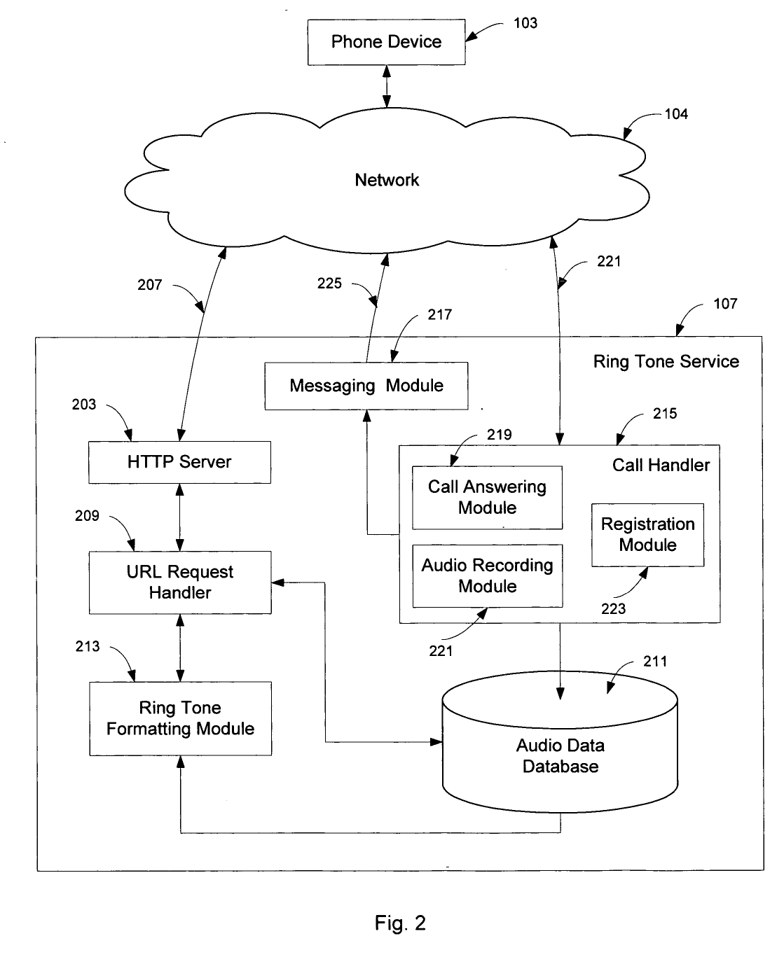

FIGS. 1 and 2 illustrate an overall system for one embodiment of a ring tone service that creates and downloads voice ring tones through a network. FIG. 1 is a system diagram illustrating one embodiment of a phone device capable of creating and downloading a voice ring tone through a network. FIG. 2 is a system diagram illustrating one embodiment of system components for a ring tone service to create and download voice ring tones through a network. Note that various software architectures may be used to implement the functions and operations described herein. The following discussion provides one example of such architecture, but it will be understood that alternative architectures may also be employed to achieve the same or similar results.

Starting with FIG. 1, a phone device 103 calls a ring tone service 107 to record an audio data into an audio data file. The ring tone service 107 notifies the phone device 103 to download a voice ring tone from the ring tone service 107 through a network 104. The voice ring tone is properly formatted for the phone device 103 from the recorded data file based on the device profile received when the phone browser contacts the service. A caller records a voice ring tone through a voice module 101 inside a cell phone device 103. The voice module sends a voice signal from the caller through a voice connection 105 to a ring tone service 107 to be recorded. The voice connection 105 is established by the phone device 103 calling a phone number associated with the ring tone service 107.

Subsequently, after the recording is completed, the ring tone service 107 may send a notification message to a messaging module 109 in the phone device through a messaging connection 111. Message connection 111 may be established by the service 107 based on a phone number associated with the phone device 103. The notification message may contain an URL for the phone device 103 to download a ring tone generated from the recording. When presented the received notification message, the caller may select the URL inside the message to activate a phone browser 113 to establish a data connection 115 to a server based on the URL for downloading the ring tone. Alternatively, the messaging module may activate the phone browser automatically. In response to the URL request from the phone browser 113, a server may send a response through the data connection 115 that includes the requested ring tone. When recognizing the content carried inside the response as a ring tone based on, for example, a response header, the phone browser 103 may forward the received content to a ring tone module 117 to complete the downloading.

Turning now to FIG. 2, according to one embodiment, the ring tone service system 107 includes an HTTP (Hypertext Transfer Protocol) server 203 to receive a URL request from a phone device 103 through a network connection 207 established by a browser executing on the phone device 103. A request handler 209 may process the URL request received by the HTTP server 203 for downloading a ring tone to the phone device 103. In one embodiment, the request handler 209 is implemented as a CGI (Common Gateway Interface) call from the HTTP server 203. In another embodiment, the request handler 209 is implemented as part of the HTTP server 203 as an API (Application Programming Interface) call. In some embodiments, the URL request handler 209 is coupled with an audio database 211 and a ring tone formatting module 213. In one embodiment, the hander 209 determines a ring tone format for the phone device 103. The formatter module 213 may format the retrieved audio data file and generate a ring tone according to the determined ring tone format.

According to one embodiment, the call hander 215 is coupled with the database 211 and a messaging module 217. In one embodiment, the call handler 215 accepts and answers a phone connection 221 from the phone device 103. In one embodiment, the call handler 215 includes a call answering module 219, an audio recording module 221 and a registration module 223. The call answering module may play an answering message to the phone device. The registration module 223, according to one embodiment, determines a phone number associated with the received phone call from the phone device 103. In one embodiment, the registration module 223 queries the database 211 to determine if the phone has been registered. The audio recording module may assign a unique ID to record the audio signal received from the phone device 103 into the database 211 according to the unique ID. Audio signals may include voice messages, pieces of music or other sounds that are sent through the phone device.

According to one embodiment, the messaging module 217 composes a notification message including a link to locate a recorded ring tone. In one embodiment, the link is a URL with the assigned unique ID. The URL may address the HTTP server 203 corresponding to the ring tone service 107. In one embodiment, the messaging module 217 sends the notification message to the phone device 103 via a message connection 225 established by the messaging module 217 according to the phone number associated with the phone device 103.

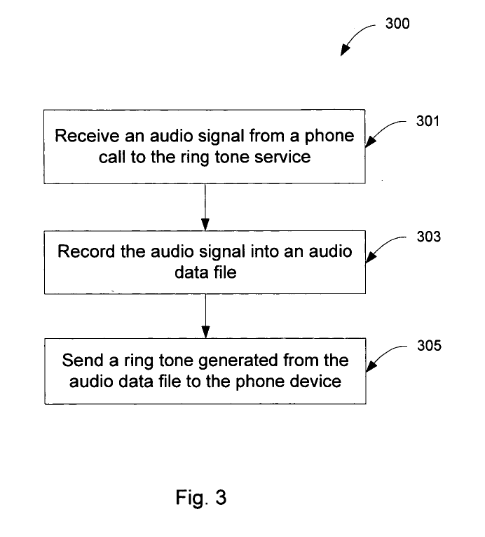

FIG. 3 is a flow diagram illustrating one embodiment of a process 300 executed in a system such as the ring tone service 107 of FIG. 2. At block 301, the process 300 records an audio signal received from a phone call. The audio signal is stored as an audio data file maintained by the ring tone service at block 303. Subsequently, a ring tone generated from the audio data file is sent to the phone device at block 305. The ring tone may be generated in response to a ring tone service request from the phone device. In one embodiment, the phone call is made through a phone device, such as a cell phone. In another embodiment, the phone call is initiated from a computer having IP (Internet Protocol) phone capability.

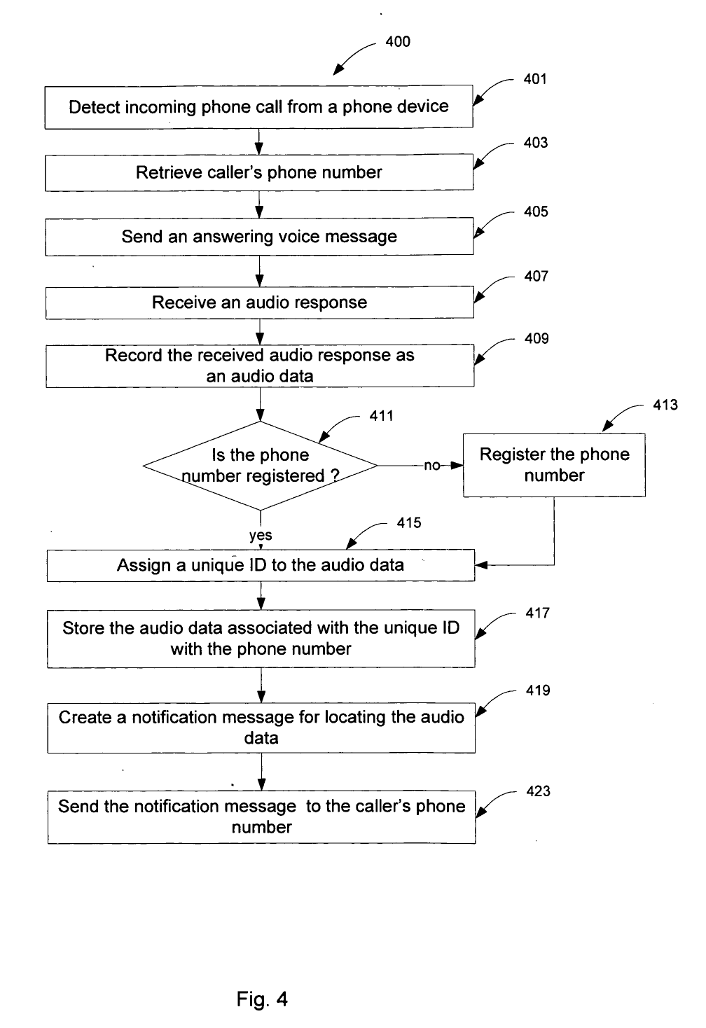

FIG. 4 is a flow diagram illustrating another embodiment of a process 400 for a ring tone service that creates a downloadable ring tone by receiving a phone call. The process 400 detects an incoming phone call from a phone device at block 401. The ring tone service may be associated with a service phone number. The incoming call may be a result of the phone device calling the service phone number. Usually, a phone device is assigned a unique phone number. In one embodiment, the phone number is associated with phone device may be retrieved based on the incoming call at block 403 received from the device corresponding to the phone number. In one embodiment, the phone number is obtained using caller ID information. When the caller has the corresponding caller ID blocked, in one embodiment, the ring tone service sends a return message informing the caller to unblock caller ID before proceeding with the service.

The process 400 may answer the incoming call by automatically playing an audio message to the phone device at block 405. In one embodiment, the answering message includes a greeting message followed by a beep. The beep signals the caller placing the call from the phone device to start an audio response. In one embodiment, an automated attendant system answers the incoming call to provide options for the caller to choose. Multiple options may include sending ring tones to friend' phone numbers, different usage pricing structures, or simply an opportunity for a caller to opt out of the service. Subsequently, the caller may start an audio response for creating a voice ring tone. In one embodiment, when receiving the audio response from the phone device at block 407, the process 400 starts recording the audio response into an audio data file at block 409. In one embodiment, the process 400 waits until the presence of an audio response after sending the answering message to start the recording. In another embodiment, the process 400 begins the recording right after sending out the answering message. The recording may complete when the caller hangs up the phone. In one embodiment, the recording completes when the process receives no audio signal from the caller for a predetermined period of time. In some embodiments, a predetermined period of time limit is imposed on the recording.

Referring to block 411 of FIG. 4, the process may determine if the phone number associated with the phone device has been registered in the ring tone service at block 411. In one embodiment, the process registers a phone number by storing an entry corresponding to the phone number into a database at block 413. In another embodiment, the process allows only calls with pre-registered phone numbers. In another embodiment, when a phone number is registered, the process notifies a remote partner web site with the newly registered phone number. Subsequently, the caller may be able to access ring tones created by the present ring tone service when accessing the partner web site. In some embodiments, the phone number needs not be registered to use the present ring tone service.

Proceeding to block 415, according to one embodiment, the process 400 assigns a unique ID to a recorded audio data file. In one embodiment, the unique ID is the caller's phone number. The audio data file and its unique ID may be stored according to the corresponding registered phone number at block 417. In one embodiment, the audio data file and its unique ID are inserted into a data base indexed by the associated registered phone number. In one embodiment, a web site for the present ring tone service is available for a caller to login to retrieve ring tones associated with the caller's phone number.

Proceeding to block 419, in one embodiment, the process 400 creates a notification message including information to locate the audio data file. In some embodiments, the notification message includes a hypertext content to locate the audio data file. In another embodiment, the notification message contains an address book entry, for example VCard entry, associated with the caller or caller's friends. Additionally, the notification message may contain an explanatory message and a password. The password may be used to log in the ring tone service from a web site hosting the service. The hypertext content may be based on HTML (Hypertext Markup Language), WML (Wireless Markup Language) or XML (Extended Markup Language). In one embodiment, the hypertext content contains information including a link that will cause a phone device to download a ring tone, a form that lets a user name the ring tone, access ring tone libraries, or share ring tones with friends. In one embodiment, the ring tone libraries may include the user's library, friend' libraries and a library available for the general public. The link may be a URL based on the unique ID. In one embodiment, the link is a URL for a generic web site of the present ring tone service. In another embodiment, the link is a URL of a partner web site which has access to the ring tones created through the present ring tone service.

Referring to block 421, in one embodiment, the process 400 sends a notification message to the caller's phone number with information to locate the audio data file. In one embodiment, the notification message is based on a messaging function such as short message or SMS. In another embodiment, the notification message is a text message. In some embodiments, the notification message may be WAP push message or MMS.

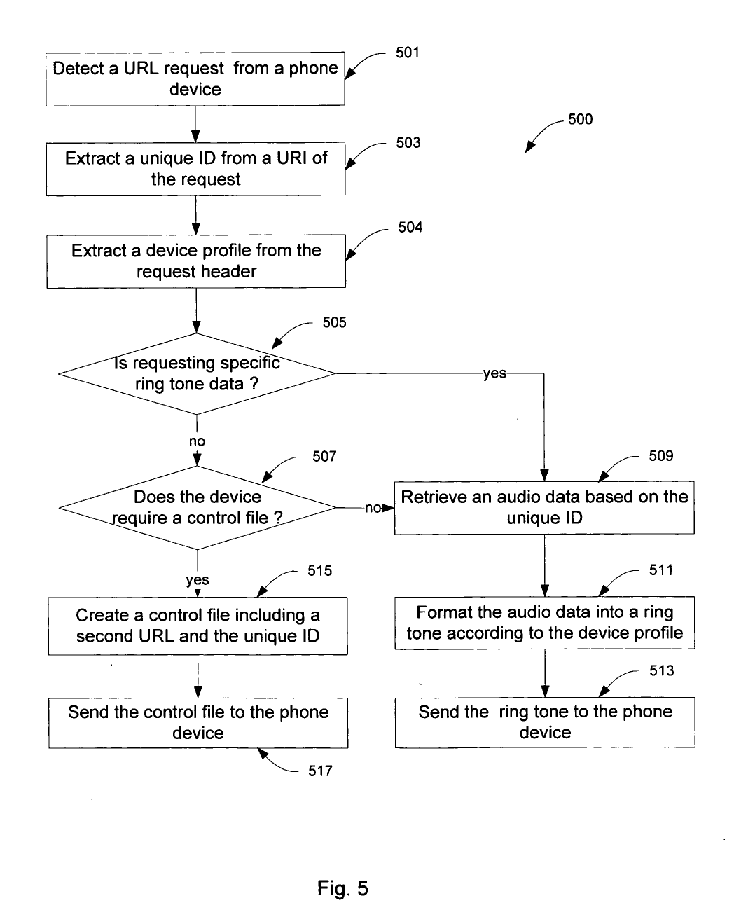

FIG. 5 is a flow diagram illustrating one embodiment of a process 500 that serves a ring tone to a phone device. The process 500 detects a URL request at block 501. The URL request may be initiated by a phone device automatically without a user activating an URL string. In one embodiment, the URL is sent from the phone device through an HTTP protocol. In one embodiment, the URL includes a unique ID embedded inside the request in a predetermined format known to the process. The process 500 may extract the unique ID from the URL accordingly at block 503. In another embodiment, the process 500 rejects the request if the URL request does not confirm to the predetermined format. The URL request may include a request header containing a device profile uniquely identifying the vendor and model of the originating phone device. The process 500 may extract the device profile from the request header at block 504. In one embodiment, the request header contains the device profile may be a standard HTTP request header. In another embodiment, the device profile is extracted from a customized HTTP header known to the calling phone device and the present ring tone service.

Proceeding to block 505, according to one embodiment, the process 500 determines if the request URL addresses a specific ring tone data. In one embodiment, for example, the process 500 identifies “.QCP” (Voice file associated with Qualcomm Pure Voice) extension from the request URL to indicate a specific ring tone data being addressed by the request URL. In one embodiment, the identification is based on a pattern from the request URL. For example, the string pattern “/q” in an example URL string “http://toktu.com/q/123456” is interpreted as a request specifically for a .QCP file. For a specific ring tone request, in one embodiment, the process 500 continues at block 509, otherwise it goes to block 507.

Proceeding to block 507, according to one embodiment, the process 500 determines if the phone device requires a control file according to the extracted device profile to download a ring tone. For example, devices based on the Qualcomm design require a control file, known as a .GCD file, to be downloaded to cause the browser to activate the ring tone download functionality. Upon receiving the control file, the activated ring tone download functionality initiates a second HTTP request, this time specifically requesting a .QCP file. A control file may contain a second URL that indicates the location of a ring tone content. Additionally, a control file may include the name and the length of a ring tone. In one embodiment, a control file is used to implement a two-step process between a phone browser and a web server to serve a CDMA (Code Division Multiple Access) phone device. On receiving the control file, the phone browser may automatically steer itself to the second URL included inside the control file.

Referring to block 509, according to one embodiment, if no control file is needed, the process 500 retrieves an audio data file based on the extracted unique ID. In one embodiment, the audio data file is obtained from a database storing the audio data file indexed by the unique ID. Based on the device profile, the process 500 may format the audio data from the audio data file and generate a ring tone compatible with the corresponding phone device at block 511. For example, many GSM (Global System for Mobile communications) devices accept ring tones in the AMR (Adaptive Multi Rate) format. Other devices, including Palm OS and Windows Mobile devices accept WAV (Windows Wave) files. In some embodiments, a predetermined format of the audio data is applied to all phone devices. Subsequently, the formatted ring tone may be sent to the phone device in response to the URL request at block 513. In one embodiment, a ring tone is sent to the phone device as an HTTP response body.

Referring to block 515, according to one embodiment, if a control file is required, the process 500 creates a control file containing a URI (Uniform Resource Identifier) that is used to construct a second URL and the unique ID from the requesting URL. In one embodiment, the unique ID is embedded inside the second URI according to a predetermined format. Subsequently, the control file may be sent to the requesting phone device as a response to the URL request at block 517. In one embodiment, the process 500 receives a second URL request to determine no control file is needed to serve the second URL request.

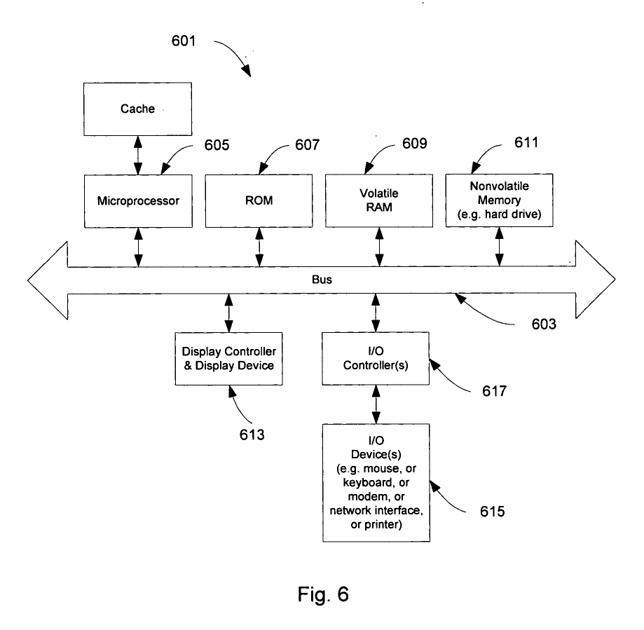

FIG. 6 shows one example of a typical computer system 601 which may be used to implement the ring tone service described above. Note that while FIG. 6 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention.

As shown in FIG. 6, the computer system 601, which is a type of a data processing system, includes a bus 603 which is coupled to a microprocessor(s) 605 and a ROM (Read Only Memory) 607 and volatile RAM 609 and a non-volatile memory 1211. The microprocessor 603 may retrieve the instructions from the memories 607 609 611 and execute the instructions to perform operations described above. The bus 603 interconnects these various components together and also interconnects these components 605, 607, 609, and 611 to a display controller and display device 613 and to peripheral devices such as input/output (I/O) devices which may be mice, keyboards, modems, network interfaces, printers and other devices which are well known in the art. Typically, the input/output devices 615 are coupled to the system through input/output controllers 617. The volatile RAM (Random Access Memory) 609 is typically implemented as dynamic RAM (DRAM) which requires power continually in order to refresh or maintain the data in the memory.

The mass storage 611 is typically a magnetic hard drive or a magnetic optical drive or an optical drive or a DVD RAM or other types of memory systems which maintain data (e.g. large amounts of data) even after power is removed from the system. Typically, the mass storage 611 will also be a random access memory although this is not required. While FIG. 6 shows that the mass storage 611 is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 603 may include one or more buses connected to each other through various bridges, controllers and/or adapters as is well known in the art.

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In addition, the operations described above may be performed by an apparatus. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

The processes and displays presented herein are not specifically related to a particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the scope of the invention.

What is claimed is:

1. A method, comprising:
recording an audio signal as an audio data file, wherein the audio signal is received in a phone call;
generating a ring tone from the audio data file; and
sending the ring tone to a phone device.

2. The method of claim 1, further comprising:
retrieving a phone number associated with the phone call.

3. The method of claim 2, wherein the recording further comprises:
assigning a unique identification to the audio data; and
storing the audio data based on the unique identification.

4. The method of claim 3, further comprising:
creating a URL including the unique identification;
creating a response data including the URL; and
sending the response data.

5. The method of claim 4, wherein the response data is a notification message and wherein the response data is sent based on the phone number.

6. The method of claim 4, wherein the response data includes hypertext content.

7. The method of claim 4, further comprising:
detecting a URL request from the phone device;
extracting the unique identification from the URL request; and
extracting a device profile associated with the phone device from a request header of the URL request.

8. The method of claim 7, wherein the generating the ring tone comprises:
retrieving the audio data file corresponding to the unique identification; and
formatting the audio data file into the ring tone according to the device profile.

9. The method of claim 7, further comprising:
creating a control file including a target URI and the unique identification; and
sending the control file to the phone device.

10. The method of claim 9, further comprising:
detecting a second URL request corresponding to the target URI;
extracting the unique identification from the second URL request;
retrieving the audio data file corresponding to the unique identification; and
formatting the audio data file into the ring tone according to a predetermined format.

11. A machine-readable storage medium having instructions, when executed by a machine, causes the machine to perform a method, the method comprising:
recording an audio signal as an audio data file, wherein the audio signal is received in a phone call;
generating a ring tone from the audio data file; and
sending the ring tone to a phone device.

12. The machine-readable storage medium of claim 11, further comprising:
retrieving a phone number associated with the phone call.

13. The machine-readable storage medium of claim 12, wherein the recording further comprises:
assigning a unique identification to the audio data; and
storing the audio data based on the unique identification.

14. The machine-readable storage medium of claim 13, further comprising:
creating a URL including the unique identification;
creating a response data including the URL; and
sending the response data.

15. The machine-readable storage medium of claim 14, wherein the response data is a notification message and wherein the response data is sent based on the phone number.

16. The machine-readable storage medium of claim 14, wherein the response data includes hypertext content.

17. The machine-readable storage medium of claim 14, further comprising:
detecting a URL request from the phone device;
extracting the unique identification from the URL request; and
extracting a device profile associated with the phone device from a request header of the URL request.

18. The machine-readable storage medium of claim 17, wherein the generating the ring tone comprises:
retrieving the audio data file corresponding to the unique identification; and
formatting the audio data file into the ring tone according to the device profile.

19. The machine-readable storage medium of claim 17, further comprising:
creating a control file including a target URI and the unique identification; and
sending the control file to the phone device.

20. The machine-readable storage medium of claim 19, further comprising:
detecting a second URL request corresponding to the target URI;
extracting the unique identification from the second URL request;
retrieving the audio data file corresponding to the unique identification; and
formatting the audio data file into the ring tone according to a predetermined format.

21. An apparatus comprises:
means for recording an audio signal from a phone call as an audio data file;
means for generating a ring tone from the audio data file; and
means for sending the ring tone to a phone device.
